(19) United States
(12) Patent Application Publication
(10) Pub. No.: US 2015/0135271 A1
(43) Pub. Date: May 14, 2015

(54) DEVICE AND METHOD TO ENFORCE SECURITY TAGGING OF EMBEDDED NETWORK COMMUNICATIONS

(71) Applicant: GM GLOBAL TECHNOLOGY OPERATIONS LLC, Detroit, MI (US)

(72) Inventor: THOMAS M. FOREST, MACOMB, MI (US)

(73) Assignee: GM GLOBAL TECHNOLOGY OPERATIONS LLC, Detroit, MI (US)

(21) Appl. No.: 14/076,434

(22) Filed: Nov. 11, 2013

(51) Int. Cl. H04L 29/06

(52) U.S. Cl. CPC H04L 63/1483; H04L 2463/142
USPC 726/4

(57) ABSTRACT

A method for managing communications from a device onboard a vehicle is provided. The method accesses a message transmitted from the device; determines whether the message is permitted; and, when the determining step determines that the message is not permitted, prevents the message from further transmission to an intended recipient device.

### TECHNICAL FIELD

Embodiments of the subject matter described herein relate generally to communications transmitted using a controller area network (CAN) protocol. More particularly, embodiments of the subject matter relate to the prevention of unauthorized messages from transmission using a CAN protocol.

### BACKGROUND

Modern vehicles utilize onboard electronic control units (ECUs) to manage a variety of functions and operations. ECUs typically utilize a controller area network (CAN) protocol for communication. A CAN is a broadcast network, which means that every message is received by every connected device, and there is no inherent authentication or indication of which device sent a message over the network. Due to these inherent traits of the communication system of the vehicle, spoofing of messages may occur. Spoofing of messages on a CAN bus involves the placement of messages on the bus from a device that represents itself as a different device, with the intent to induce the vehicle to behave in a manner that is unintended by the vehicle operator. A compromised device may mistakenly or maliciously spoof messages; this intrusive device may send messages on the CAN bus, and the receiving device(s) act on the messages, unaware of their true source. Hardware modifications to the CAN system may be performed in an effort to minimize the risk of message spoofing. However, these modifications may be prohibitively costly to vehicle manufacturers.

Accordingly, it is desirable to stop compromised devices from sending messages to other devices, other than the devices the compromised device normally communicates with. Furthermore, other desirable features and characteristics will become apparent from the subsequent detailed description and the appended claims, taken in conjunction with the accompanying drawings and the foregoing technical field and background.

### BRIEF SUMMARY

Some embodiments provide a method for managing communications from a device onboard a vehicle. The method accesses a message transmitted from the device; determines whether the message is permitted; and, when the determining step determines that the message is not permitted, prevents the message from further transmission to an intended recipient device.

Some embodiments provide a protection apparatus for preventing transmission of unapproved communications from a device onboard a vehicle. The protection apparatus comprises a digital logic architecture, including: a transmit data signal input port, configured to receive a data communication for further processing; and a transmit enable signal input port, configured to receive an activation signal transmitted by a network controller; wherein the protection apparatus is configured to: receive the activation signal and the data communication, transmitted by the network controller; determine whether the data communication is approved; and prevent further transmission of the activation signal to block receipt of the data communication at a network transceiver, when the data communication is not approved.

Some embodiments provide a system for enforcing security tagging of communications from a device onboard a vehicle. The system includes: a controller element, configured to transmit a communication via a communication network onboard a vehicle, wherein the communication comprises a message and a tag; and a protection element operatively associated with the controller element, configured to: access the communication transmitted by the controller element; determine whether the tag comprises an authorized label; and prevent the communication from further transmission when the tag does not comprise an authorized label.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a functional block diagram of a vehicle that includes an onboard communication network, in accordance with an embodiment;

FIG. 2 is a flowchart that illustrates an embodiment of a process for enforcing security tagging of communications from a device onboard a vehicle;

FIG. 3 is a flowchart that illustrates an embodiment of a process to determine whether a message, transmitted from a device, is permitted;

FIG. 4 is a system diagram of a protection element operatively associated with a device, in accordance with an embodiment; and

FIG. 5 is a diagram of implementations of a message tag, in accordance with the embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The subject matter presented herein relates to methods and apparatus used to detect unauthorized (i.e., spoofed) messages from transmission onto an automotive communication network. In certain embodiments, a security tag is analyzed to determine whether a message is permitted for transmission. In some embodiments, an entire message is analyzed to determine if the message is permitted for transmission. When the analysis determines that the message is not authorized, further transmission of the message is prevented.

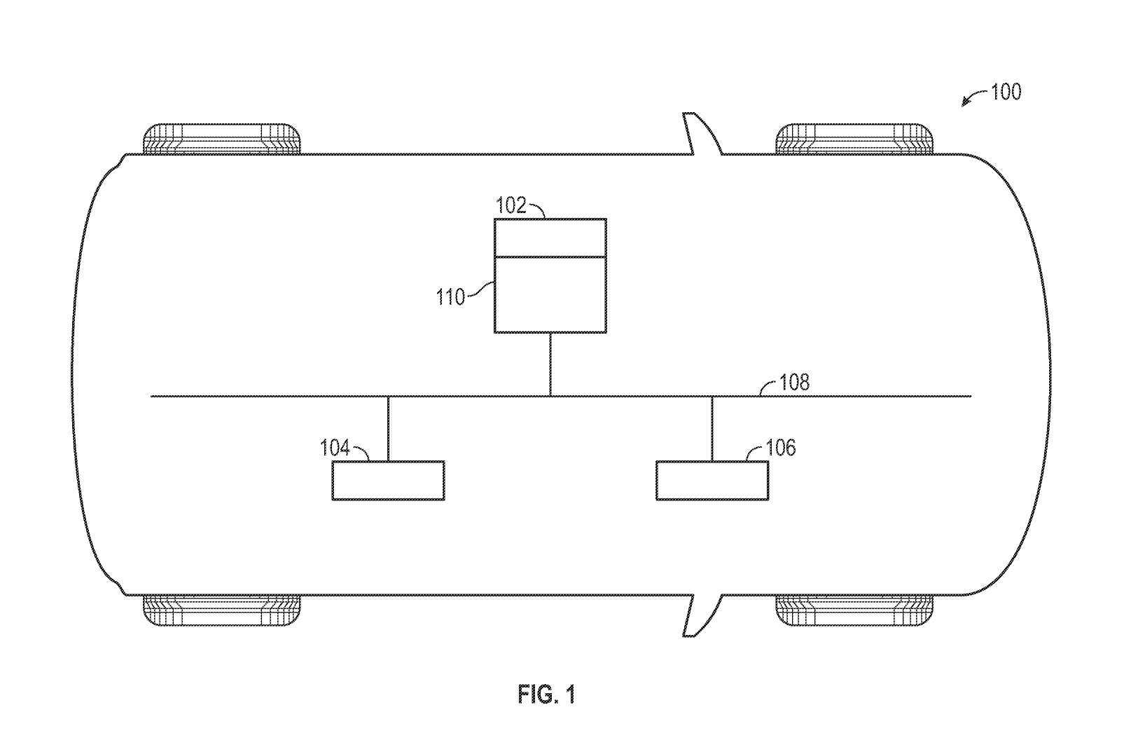

Referring now to the drawings, FIG. 1 is a functional block diagram of a vehicle 100 that includes an onboard communication network 108, in accordance with the disclosed embodiments. The vehicle 100 may be any one of a number of different types of types of automobiles (sedans, wagons, trucks, motorcycles, sport-utility vehicles, vans, etc.), aviation vehicles (such as airplanes, helicopters, etc.), watercraft (boats, ships, jet skis, etc.), trains, all-terrain vehicles (snowmobiles, four-wheelers, etc.), military vehicles (Humvees, tanks, trucks, etc.), rescue vehicles (fire engines, ladder trucks, police cars, emergency medical services trucks and ambulances, etc.), spacecraft, hovercraft, and the like.

The onboard communication network 108 provides a communication platform for a plurality of devices (102, 104, 106). Although only three devices are shown for the sake of simplicity, the vehicle 100 may include more or less than three, as appropriate for the particular embodiment. For purposes of this application, “device” is a generic term for any embedded system that controls one or more of the electrical system or subsystems in a motor vehicle. Each device may otherwise be referred to as an electronic control unit (ECU). Examples of common devices may include, without limitation: an airbag module, a body controller, a suspension module, a driver door module, a cruise control module, an instrument panel, a climate control module, a transmission controller, a power distribution module, an anti-lock braking system (ABS) module, and the like.

Most vehicles utilize a controller area network (CAN) protocol for communications among its devices. CAN is a broadcast serial bus standard designed to allow microcontrollers and devices to communicate with each other within a vehicle and without a host computer. Using the CAN protocol, the onboard communication network 108 is implemented as a CAN bus, in which each device is able to send and receive messages. Messages are broadcast to all devices coupled to the communication network 108, and devices identify which messages to process (and which messages to discard) by examining information in the message. In particular, the header portion of a CAN message contains a field known as the Arbitration Identifier (or more commonly just Identifier) which is often used to indicate information about the message. Some systems include information that describes the content of the messages here, while some systems include source and/or destination information in the identifier, and some systems use a combination of all three. CAN controllers are set up to provide filtering based on the identifier, so it is possible for a node to accept or reject messages based on the characteristics in the identifier.

Device 102 is shown to be communicatively coupled to a protection element 110. In certain implementations, the protection element 110 is an independent hardware apparatus, separate and distinct from the device 102 itself. In other embodiments, the protection element 110 may be incorporated into the device 102 hardware, and in still other embodiments, the positioning and/or configuration of the protection element 110 may be a hybrid of both arrangements. The protection element 110 is suitably configured to prevent unauthorized communications, originating at device 102, from being transmitted over the communication network 108. Generally, unauthorized communications are the result of a compromised device 102 due to malicious activity (e.g., hacking into the device 102). In some embodiments, each device (102, 104, 106) may be coupled to its own protection element. In other embodiments, protection elements 110 are utilized by a subset of the total number of devices (102, 104, 106) coupled to the communication network 108.

The protection element 110 may be implemented or performed with one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the protection element 110 may be realized as one or more microprocessors, controllers, microcontrollers, or state machines. Moreover, the protection element 110 may be implemented as a combination of computing devices, e.g., a combination of digital signal processors and microprocessors, a plurality of microprocessors, one or more microprocessors in conjunction with a digital signal processor core, or any other such configuration.

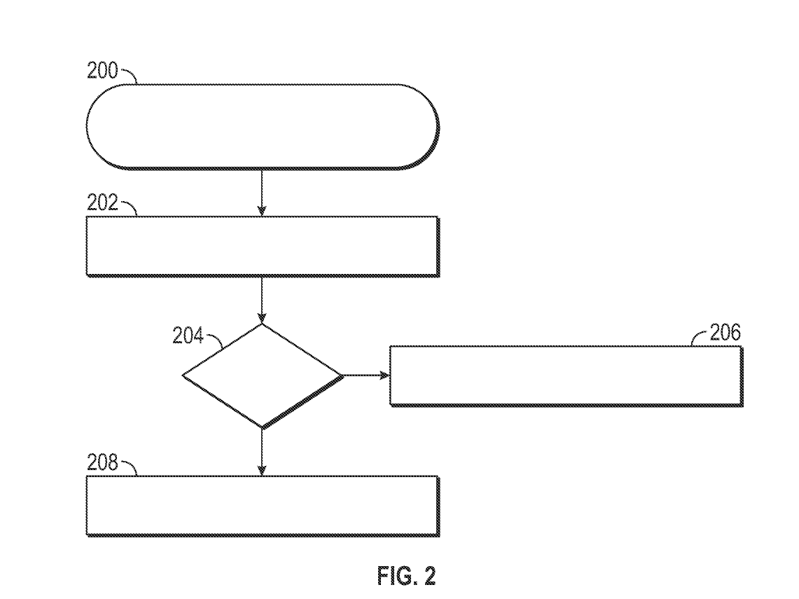

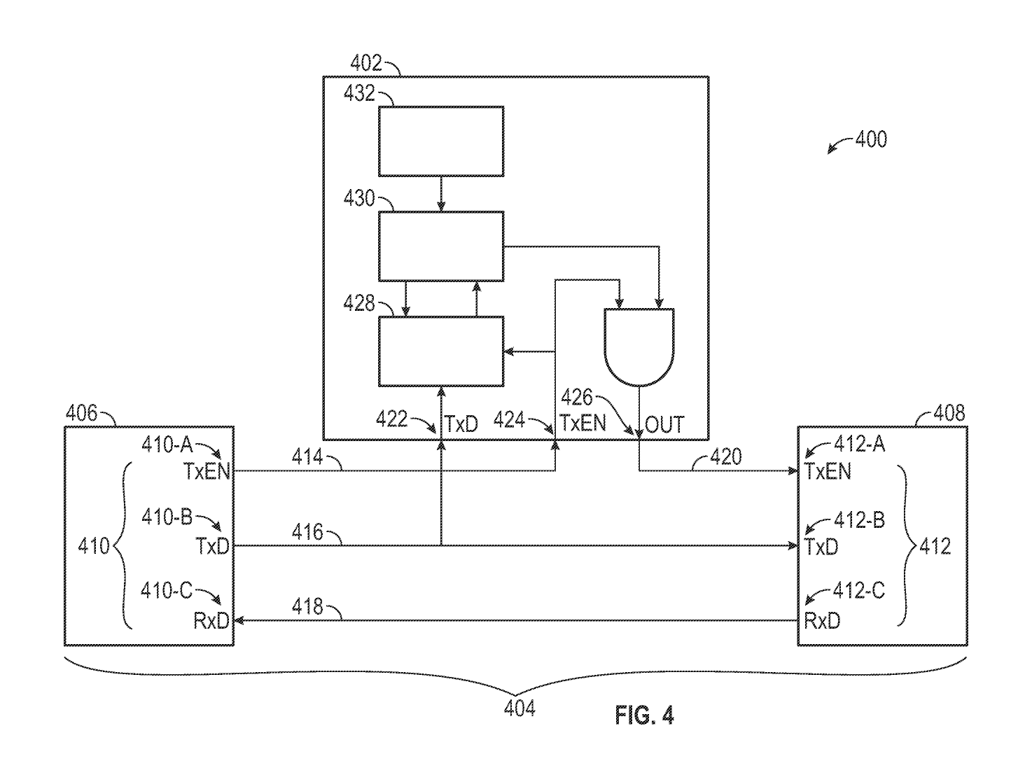

FIG. 2 is a flowchart that illustrates an embodiment of a process 200 for enforcing security tagging of communications from a device onboard a vehicle. The various tasks performed in connection with process 200 may be performed by software, hardware, firmware, or any combination thereof. In preferred embodiments, the process 200 is performed by a protection element communicatively coupled to a device onboard a vehicle. For illustrative purposes, the following description of process 200 may refer to elements mentioned in connection with FIGS. 1, 4, and/or 5. In practice, portions of process 200 may be performed by different elements of the described system, e.g., a protection element, a device onboard a vehicle, a vehicle communication network, a controller, or a transceiver. It should be appreciated that process 200 may include any number of additional or alternative tasks, the tasks shown in FIG. 2 need not be performed in the illustrated order, and process 200 may be incorporated into a more comprehensive procedure or process having additional functionality not described in detail herein. Moreover, one or more of the tasks shown in FIG. 2 could be omitted from an embodiment of the process 200 as long as the intended overall functionality remains intact.

For ease of description and clarity, this example assumes that the process 200 begins by accessing a message transmitted from the device (step 202). Accessing a message transmitted by a device on the vehicle involves “eavesdropping”, or in other words, retrieving the contents of the message without altering the original transmission in any way. Generally, the message is generated internally, by a controller that is part of the device, and transmitted by a transceiver that is also part of the device. The message is also accessed internally, as the message is being transmitted from the controller to the transceiver. The process 200 allows transmission of the message from the controller to proceed as it normally would, without introducing a delay in the transmission of communication.

Next, the process 200 determines whether the message is permitted for further transmission (step 204) to an intended recipient device. The process 200 internally accesses the message and analyzes its contents to determine whether the message is legitimate and therefore permitted to be transmitted, externally, to the intended recipient device. This evaluation is performed as the message is being transmitted, without introducing delay into the process 200, and concludes before transmission of the message is complete.

If the message is permitted (the “Yes” branch of 204), then the process 200 allows the transmission of the message to the intended recipient to complete without interruption (step 206). Legitimate messages include messages that are created according to standard operating procedures of the vehicle-based communication network and messages which are transmitted from an appropriate and secure device. In some embodiments, the message is transmitted directly to the intended recipient device, and in other embodiments, the message is broadcast over a vehicle communication network, such as a CAN, to be received by all devices in the vehicle and applied by the intended recipient device.

If the message is not permitted (the “No” branch of 204), then the process 200 prevents transmission of the message to the intended recipient device by interrupting the transmission before completion of the message (step 208). Generally, the interruption occurs during transmission of the message, resulting in an incomplete message transmitted via the vehicle communication network. The intended recipient device is unable to process the incomplete message. In certain embodiments utilizing a CAN communication protocol, the incomplete message is disregarded or “dropped” by any other devices communicatively coupled to the CAN bus.

A message is not permitted for further transmission when it is not a legitimate message. This condition may include one or more of the following scenarios, without limitation: when it originates at an insecure device, when it originates from a device that is not approved to send the message, when it originates from a device that is identifying itself incorrectly (e.g., the device transmitting the message identifies itself as another device), and/or when the message itself is not an approved message, as defined by the intended recipient device.

In essence, the process 200 speculatively allows transmission at the beginning portion of the message, makes a decision (based on information in the beginning portion of the message) whether transmission should be allowed to continue, and then disables transmission before the end of the message if it is decided that the message is invalid. In certain embodiments, the CAN communication protocol will naturally cause incomplete messages (i.e., messages where the transmission is interrupted) to be discarded by all receivers. This is done without any modification of the CAN protocol.

In certain embodiments, when the message is not permitted, the process 200 not only prevents the message from further transmission, but it also initiates a penalty period of time in which the device from which the message originated is prevented from transmitting additional messages. Generally, messages that are not permitted or authorized originate at a compromised device, and in embodiments using a CAN protocol, these compromised devices continually interrupt the transmissions on the vehicle network. Using the penalty time allows other devices using the vehicle communication network an opportunity to transmit data. The penalty time varies based on system conditions, design preference, etc.

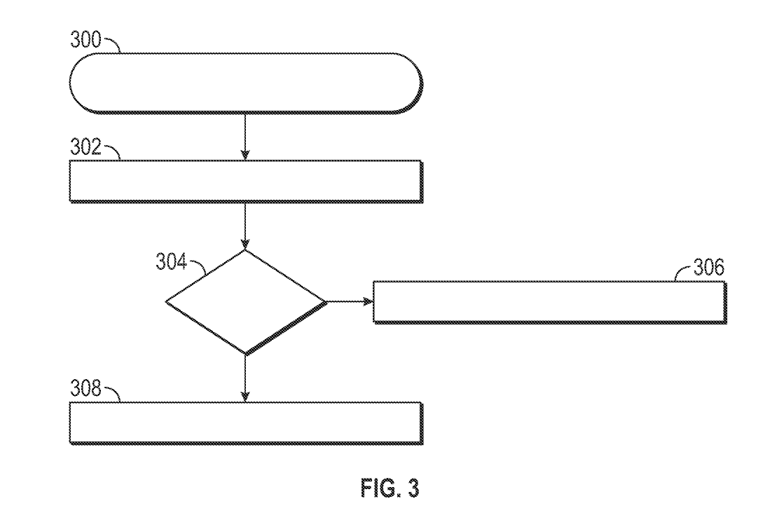

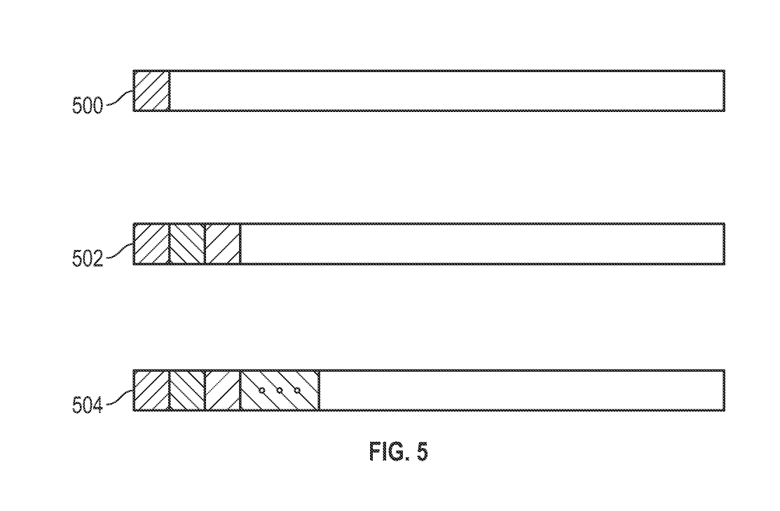

FIG. 3 is a flowchart that illustrates an embodiment of a process to determine whether a message, transmitted from a device, is permitted. Here, the process 300 begins by identifying a tag embedded in the message (step 302). Generally, the tag is a subset of the message designated for analysis and decision-making and may include a portion of the message of any size, up to and possibly including the entire message. Referring now to FIG. 5, several diagrams of implementations of a message tag are shown, including, without limitation: a single-bit tag 500; a multi-bit tag 502, showing for example, three bits used in message analysis; and a whole-identifier tag 504, in which an entire arbitration identifier or an entire header is utilized in message analysis.

Referring back to FIG. 3, after the tag has been identified (step 302), the tag is assessed to determine whether it is valid (step 304). The process 300 applies specific tagging rules in evaluating the validity of the tag. In certain embodiments, the tagging rules dictate that the process 300 evaluates a single bit tag to determine validity of the tag. (FIG. 5 illustrates this single-bit tag 500.) In this example, a single bit in each message is designated as an “insecure” bit, which is set when the device from which the message originated is not guaranteed to be secure. The insecure bit is not set when the device is designated as a secure device. The condition required for the insecure bit to be set is potential insecurity of the device, but not necessarily absolute insecurity of the device. Devices which may not guarantee security may include, without limitation, devices with external-facing inputs, such as a radio or onboard media/entertainment module.

When the insecure bit is set to a value that is not designated as an appropriate value for the device, the tag is determined to be invalid. For example, an insecure device may transmit a message in which the insecure bit set, and the tag would be determined to be valid. In this case, the insecure device is utilizing a tag that is proper for transmission of the message, and the tag is therefore proper. However, it is not proper for an insecure device to send a message in which the insecure bit is not set. In this case, the tag is determined to be invalid. This process prevents an insecure device from posing as a secure device for purposes of message transmission.

In some exemplary embodiments, the tagging rules dictate that the process 300 evaluates a multi-bit tag, comprising a device identifier, embedded within the message to determine whether the tag is valid. (FIG. 5 illustrates this multi-bit tag 502.) In these embodiments, the tag includes one or more bits embedded in the message act as an identifier for the device from which the message originated. Here, when the message originates from an incorrect device, the message will not be transmitted. A device onboard a vehicle is not permitted to impersonate other devices to execute unapproved commands. For example, the process 300 may be applied to a vehicle radio, ensuring that all messages transmitted from the vehicle radio have the same device identifier. If the vehicle radio attempts to transmit a message using the device identifier for the suspension module, for instance, the process 300 uses the applicable tagging rules to determine that the tag is invalid.

In some embodiments, the tagging rules dictate that the process 300 evaluates the entirety of an identifier of the message to determine whether the tag is valid. (FIG. 5 illustrates this whole-identifier tag 504.) In these embodiments, the tag includes all bits contained in an identifier of the message, and the tag is compared to a predefined list of acceptable tags. In certain embodiments using a CAN communication protocol, each message includes a header, and the header of the message further includes an arbitration identifier. In some embodiments, the tag includes the arbitration identifier, which may be compared to a predefined list of acceptable arbitration identifiers to determine whether the tag is valid. In other embodiments, the arbitration identifier plus designated additional bits from the header may be included in the tag. In other embodiments, the arbitration identifier, additional designated bits from the header, and additional designated bits from the message may be included in the tag.

Using the previous example, if a vehicle radio attempts to send a message that would be correctly sent by the vehicle suspension module, such as a command to activate braking, the process 300 initiates a lookup to determine whether an identifier associated with the command to activate braking is on the predefined list of approved identifiers that may be sent by the vehicle radio. When the identifier is not found on the predefined list, the process 300 uses the applicable tagging rules to determine that the tag is invalid.

If the tag is determined to be valid (the “Yes” branch of 304), then the process 300 flags the message as “permitted” (step 306). Using any of the previously described embodiments, the process 300 analyzes the tag using the tagging rules to determine if the tag is valid. If the tag is valid, then the message is approved for further transmission of the message to the intended recipient device. If the tag is determined not to be valid (the “No” branch of 304), then the process 300 flags the message as not permitted (step 308), and the message is not approved for further transmission to the intended recipient device.

FIG. 4 is a diagram of a system that includes an exemplary embodiment of a protection element 402 operatively associated with a device 404. The protection element 110 shown in FIG. 1 may be implemented in accordance with the configuration shown in FIG. 4, and in accordance with the following description of the protection element 402. Generally, the device 404 operates in a vehicle communication network (shown as reference 108 in FIG. 1) and, in certain embodiments, uses a CAN communication protocol. The device 404 includes a controller 406 and a transceiver 408. Messages generated by the device 404 originate at the controller 406, and are transmitted to the transceiver 408 using communication lines that connect input/output (I/O) ports 410 on the controller 406 to I/O ports 412 on the transceiver 408. As shown, the controller 406 transmits a transmit-enable signal 414, and a data signal 416, to the transceiver 408. The controller 406 also receives a data signal 418 transmitted from the transceiver 408.

The I/O ports 410 on the controller 406 allow the controller 406 and the transceiver 408 to exchange data transmissions (also called messages). As shown, a data signal 416 may be transmitted from the transmit-data port 410-B on the controller 406 to the transmit-data port 412-B on the transceiver 408. In contrast, the receive-data port 410-C on the controller 406 receives a data signal 418 from the receive-data port 412-C on the transceiver 408. However, the transceiver 408 cannot further transmit (e.g., transmit over a vehicle communication network that is external to the device) a data signal 416 without permission from the controller 406, in the form of a transmit-enable signal 414. When a transmit-enable signal 414 is received at the transceiver 408, the transceiver 408 is able to transmit the data signal 416 to the communication network (not shown), for further transmission to an intended recipient device. In embodiments using a CAN communication protocol, the data signal 416 is broadcast to the rest of the devices onboard the vehicle.

The protection element 402 is configured to intercept the transmit-enable signal 414, or in other words, to receive the transmit-enable signal 414 transmitted by the controller 406, and to transmit a second transmit-enable signal 420 to the transceiver 408, unless the data signal 416 is determined to be invalid. As shown, the transmit-enable signal 414 is diverted from its intended receipt at transmit-enable port 412-A at the transceiver 408, to be received at transmit-enable port 424 of the protection element 402. The transmit-enable signal 414 is configured to activate the transmission capabilities of the transceiver 408, enabling the transceiver 408 to transmit data received at the transmit-data port 412-B, or in this example, to further transmit the received data signal 416. However, the protection element 402 intercepts the transmit-enable signal 414, preventing the transmit-enable signal 414 from being received by the transmit-enable port 412-A. The protection element 402 transmits the new transmit-enable signal 420, allowing the transceiver 408 to further transmit the data signal 416 using the vehicle communication network. The protection element 402 is configured to continue transmitting the new transmit-enable signal 420 until or unless internal decision logic 430 determines that the data signal 416 is invalid.

The protection element 402 is further configured to “eavesdrop” on the data signal 416. In other words, the protection element 402 receives the data signal 416 (for further analysis and decision-making) but does not prevent transmission of the data signal 416 to the transceiver 408.

The protection element 402 uses decoding logic 428, decision logic 430, and tagging rules 432 to determine whether the message sent via the data signal 416 is permitted for communication to the transceiver 408, for further transmission to the communication network. As shown, the data signal 416 is received at transmit-data port 422 of the protection element 402, and the transmit-enable signal 414 is received at transmit-enable port 424 of the protection element 402. Once received, the transmit-enable signal 414 activates the decoding logic 428. As described above with regard to FIG. 3, the decoding logic 428 of the protection element 402 identifies the tag, or in other words, the subset of the message that will be analyzed.

After the decoding logic 428 is used to identify the tag, the protection element 402 utilizes decision logic 430 to analyze the tag to determine whether the tag is valid. The decision logic 430 applies specific tagging rules 432 in evaluating the validity of the tag, as described above with regard to FIG. 3. In certain embodiments, the tagging rules 432 dictate that the decision logic 430 evaluates a single bit tag to determine validity of the tag (i.e., a single-bit tag). In some embodiments, the tagging rules 432 dictate that the decision logic 430 evaluates a multi-bit tag embedded within the message. In some embodiments, the tagging rules 432 dictate that the tag comprises an identifier, which must be compared to a predefined list of approved identifiers in order to be designated valid.

Using any of these tagging rules 432, the decision logic 430 analyzes the tag to determine if the tag is valid. The transmit-enable signal 414 is transmitted to transmit-enable port 412-A from the protection element 402, unless the tag is determined to be invalid. Generally, the tag is evaluated and its validity is determined during transmission of the data signal 416. If the tag is determined to be invalid, the transmit-enable signal 420 is no longer transmitted. The transceiver 408 has been transmitting the data signal 416 to the vehicle communication network (not shown), but halts this transmission, mid-message, when the transmit-enable signal 420 is no longer being received. This results in an incomplete message that has been transmitted to the vehicle communication network, which will be discarded by any devices that receive it. If the tag is determined to be valid, then the transmission is permitted to continue and a complete message will be received by an intended recipient device via the vehicle communication network.

In embodiments where the system 400 is implemented as part of a vehicle communication system utilizing a CAN protocol, an additional step must be made to accommodate potential error conditions. An error condition may be detected in the message if anything within the message does not conform to the normal rules included in CAN protocol, and the device detecting the error is responsible for generating a CAN error flag when this occurs. The CAN error flag includes six consecutive bits transmitted from the transmit-data port 410-B and, if transmitted at a particular time, may cause the protective element 402 to improperly decide that the tag is invalid. In particular, it is possible that the protective element will determine that a tag is invalid even though the device is behaving entirely correctly. In this case, it is unknown whether the tag is valid or invalid, but the data signal 416 would be prevented from further transmission by the transceiver 408 due to the error handling mechanisms of the CAN protocol.

To accommodate this possibility, and to accurately evaluate validity of the tag, the protection element 402 allows a time-lapse to accommodate the six consecutive bits of the error flag. The device is allowed to continue transmission for up to six bit times after the detection of an invalid tag. This allows the completion of the transmission of a CAN error frame (if that is the cause of the invalid tag determination) but does not allow a message to be accepted by the receivers. If the device ceases transmission within those six bit times, the device is assumed to be operating correctly, even if the tag is incorrect. If the device continues to attempt transmission after those six bit times, the tag is considered invalid, and further transmission will be disabled.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for managing communications from a device onboard a vehicle, the method comprising:
accessing a message transmitted from the device;
determining whether the message is permitted; and
when the determining step determines that the message is not permitted, preventing the message from further transmission to an intended recipient device.

2. The method of claim 1, wherein the determining step further comprises:
identifying a tag embedded in the message;
assessing validity of the identified tag; and
when the assessing step determines that the tag is not valid, flagging the message as not permitted.

3. The method of claim 2, further comprising:
when the assessing step determines that the tag is valid, allowing further transmission of the message to the intended recipient device.

4. The method of claim 2, wherein the determining step further comprises:
determining whether the tag comprises an identifier associated with the device; and
when the tag does not comprise the identifier, flagging the message as not permitted.

5. The method of claim 2, wherein the assessing step further comprises:
identifying an existing security condition of the device;
obtaining a security identifier from the tag, the security identifier indicating a communicated security condition of the device; and
when the existing security condition of the device and the security identifier do not match, flagging the message as not permitted.

6. The method of claim 2, wherein the determining step further comprises:
performing a lookup to determine whether the message comprises an approved communication for the device, based on the identified tag;
wherein the tag identifies an origin of the message.

7. The method of claim 1, wherein, when the message is not permitted, the method of claim 1 further comprises:
preventing the device from transmitting communications for a designated period of time.

8. The method of claim 1, wherein, when the message is not permitted, the method of claim 1 further comprises:
delaying the preventing step for a designated period of time;
assessing whether the message is permitted, after the designated period of time; and
performing the preventing step when the message is not permitted.

9. A protection apparatus for preventing transmission of unapproved communications from a device onboard a vehicle, the protection apparatus comprising a digital logic architecture, including:
a transmit data signal input port, configured to receive a data communication for further processing; and
a transmit enable signal input port, configured to receive an activation signal transmitted by a network controller;
wherein the protection apparatus is configured to:
receive the activation signal and the data communication, transmitted by the network controller;
determine whether the data communication is approved; and
prevent further transmission of the activation signal to block receipt of the data communication at a network transceiver, when the data communication is not approved.

10. The protection apparatus of claim 9, wherein the protection apparatus further comprises:
a transmit enable signal output port, configured to transmit the activation signal to a network transceiver when the data communication is approved.

11. The protection apparatus of claim 9, wherein the protection apparatus is further configured to evaluate a subgroup of the data communication to determine whether the data communication is approved.

12. The protection apparatus of claim 9, wherein the protection apparatus is further configured to:
identify an existing security condition for the device;
evaluate a subgroup of the data communication to determine whether the data communication is approved, wherein the subgroup of the data communication comprises a security flag for the device; and
when the security flag indicates a security condition different than the existing security condition, determine the data communication is not approved.

13. The protection apparatus of claim 9, wherein the protection apparatus is further configured to:
evaluate a subgroup of the data communication to determine whether the data communication is approved, wherein the subgroup of the data communication comprises an identifier for the device; and
when the identifier does not correctly identify the device, determine the data communication is not approved.

14. The protection apparatus of claim 9, wherein the protection apparatus is further configured to perform a lookup to determine whether the data communication is approved.

15. The protection apparatus of claim 9, wherein:
the network controller comprises a controller area network (CAN) controller;
the network transceiver comprises a CAN transceiver; and
the device comprises an electronic control unit (ECU) onboard the vehicle.

16. A system for enforcing security tagging of communications from a device onboard a vehicle, the system comprising:
a controller element, configured to transmit a communication via a communication network onboard a vehicle, wherein the communication comprises a message and a tag; and
a protection element operatively associated with the controller element, configured to:
access the communication transmitted by the controller element;
determine whether the tag comprises an authorized label; and
prevent the communication from further transmission when the tag does not comprise an authorized label.

17. The system of claim 16, further comprising:
a transceiver element, configured to:
receive the communication from the protection element when the tag comprises an authorized label; and
transmit the communication to an intended recipient device via the communication network.

18. The system of claim 17, wherein the protection element is further configured to:
prevent the transceiver from transmitting communications for a designated period of time, when the tag does not comprise an authorized label.

19. The system of claim 16, wherein, when the message is not permitted, the protection element is further configured to:
delay the preventing step for a designated period of time;
assess whether the message is permitted, after the designated period of time; and
perform the preventing step when the message is not permitted.

20. The system of claim 16, wherein the protection element is further configured to enable further transmission of the communication when the tag comprises an authorized label.
